(19) United States
(12) Patent Application Publication
(10) Pub. No.: US 2004/0027461 A1
(43) Pub. Date: Feb. 12, 2004

(54) Digital camera image re-compression feature associated with an image deletion selection

(76) Inventor: David W. Boyd, Greeley, CO (US)

Correspondence Address: HEWLETT-PACKARD COMPANY, Intellectual Property Administration, P.O. Box 272400, Fort Collins, CO, 80527-2400, US

(21) Appl. No.: 10/217,563

(22) Filed: Aug. 12, 2002

(51) Int. Cl. H04N 5/228

(52) U.S. Cl. 348/222.1

(57) ABSTRACT

A digital camera includes a capability for recovering memory by converting an existing digital photograph to a lower quality setting so that the photograph consumes less memory. The camera's user interface associates the conversion capability with the deletion of photographs. The original higher quality photograph may optionally be automatically deleted as part of the conversion process.

### FIELD OF THE INVENTION

The present invention relates generally to digital photography.

### BACKGROUND OF THE INVENTION

A digital camera creates a digital data file that, when properly interpreted, can be used to reproduce a scene as photographed by the camera. The digital data file is often referred to as a digital photograph, an image, or simply a photograph. A camera typically comprises memory for storing several digital photographs. Often, memory is built into the camera, and also may be added by inserting a memory card or other removable storage medium into the camera.

Regardless of the storage medium used, memory for storing digital photographs is often in limited supply. A photographer typically may have a limited number of memory cards or other media, and may take enough photographs to fill the available memory without having an opportunity to “upload” the photographs to a computer or other storage device, which would free up the memory for more photographs. For example, the photographer may be traveling and not have access to means for uploading his or her photographs for an extended time.

Once the available memory is filled, the photographer may be forced to delete existing digital photographs in order to take new ones. This results in the permanent loss of photographs that the photographer may desire to keep.

A few digital cameras may provide an alternative method of recovering memory space without the total loss of existing photographs. Typically, a digital camera provides several varying levels of picture quality from which a photographer may choose when taking a photograph. Often, the highest quality level or setting produces a digital photograph that contains as many picture elements, or “pixels,” as are available on the electronic sensor that the camera uses to take photographs. In addition, the highest quality level or setting may cause the camera to use digital image compression settings that preserve relatively more detail in the resulting photograph as compared with other settings. Lower quality settings may produce digital photographs with fewer pixels, or with more aggressive compression settings that remove detail from the photograph, or with some combination of these. A lower quality setting generally produces a digital photograph that consumes less memory than a photograph taken with a higher quality setting. A digital camera may have several quality settings available.

In the alternative memory recovery method, the camera provides a way to convert an existing digital photograph from its initial quality level to a lower quality level, which generally consumes less memory. This process may be called re-compression or quality reduction. Typically, recovering memory using this method is a two-step process (excluding confirmation indications). A lower quality version of a photograph is created in the first step, but the original higher quality version is kept in the camera until it is explicitly deleted by the photographer in a second step. This two-step process may require the photographer to navigate multiple command menus on the camera, and at least temporarily results in an increase in memory consumption while the two versions of the photograph are resident.

There is a need for a more convenient and memory-efficient method of recovering memory in a digital camera.

### SUMMARY OF THE INVENTION

A digital camera includes a capability for recovering memory by converting an existing digital photograph to a lower quality setting so that the photograph consumes less memory. The camera's user interface associates the conversion capability with the deletion of photographs. The original higher quality photograph may optionally be automatically deleted as part of the conversion process.

### BRIEF DESCRIPTION OF THE DRAWINGS

FIG. 1 depicts a simplified block diagram of an example digital camera.

FIG. 2 depicts a portion of an example camera user interface.

FIG. 3 depicts an example confirmation menu.

FIG. 4 depicts a camera that includes an example embodiment of the invention.

FIG. 5 depicts an example confirmation menu.

FIG. 6 depicts an example confirmation menu including a choice of disposition of the original photograph.

FIG. 7 depicts a second camera with a different user interface that includes a second example embodiment of the invention.

FIG. 8 shows a direct view of an example display of the camera of FIG. 7.

FIG. 9 shows a menu superimposed on the example display of FIG. 8.

FIG. 10 depicts an example menu with choices for deleting and re-compressing photographs.

### DETAILED DESCRIPTION OF THE PREFERRED EMBODIMENT

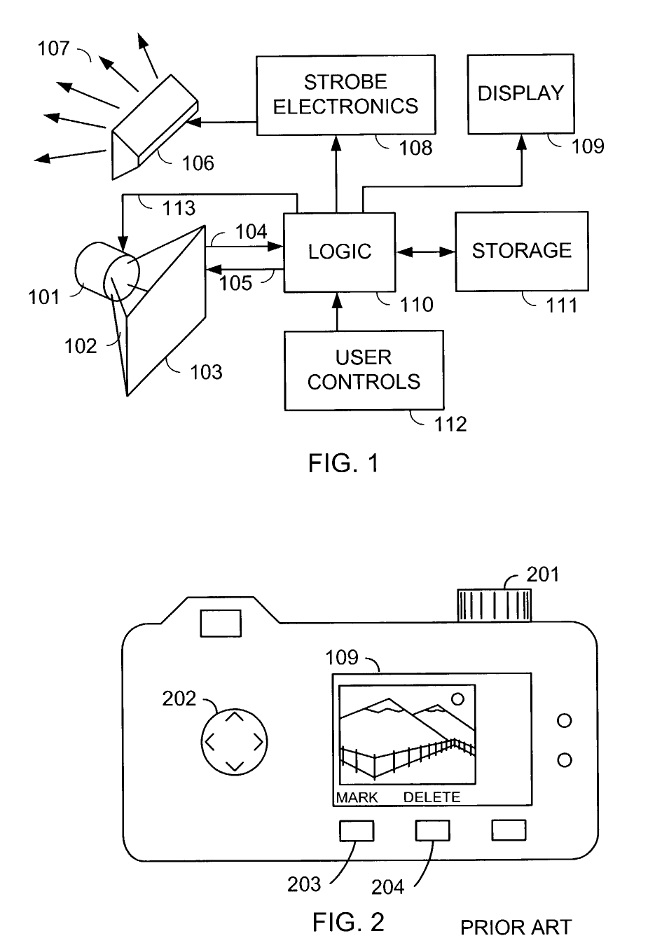

FIG. 1 depicts a simplified block diagram of an example digital camera. A lens 101 gathers light from a scene (not shown). The lens redirects the light so that the redirected light 102 forms an image of the scene on an electronic array light sensor 103. Electronic array light sensor 103 may be a charge-coupled device (CCD) sensor, an active pixel complementary metal oxide semiconductor (CMOS) sensor, or another kind of sensor. Image data 104 from electronic array light sensor 103 may be transmitted to a logic unit 110. The logic unit may comprise a microprocessor, a digital signal processor, one or more application specific integrate circuits (ASICs), or some combination of these, and may control the operation of electronic array light sensor 103 using control signals 105. Logic unit 110 may also control the operation of lens 101 using control signals 113. Logic unit 110 may also process digital photographs in various ways, including applying image compression techniques to them. The camera may comprise a strobe 106 for supplying light 107 to the scene. Strobe 106 may be controlled by strobe electronics 108, which are in turn controlled by logic unit 110.

The camera may also comprise storage 111, which may be nonvolatile memory for relatively long term storage of digital photographs taken by the camera. Some or all of the storage may be incorporated as part of logic unit 110. For example, the logic unit may comprise some flash memory, which is a form of nonvolatile re-writable semiconductor memory. Logic unit 110 may also comprise other kinds of memory such as random access memory (RAM), read-only memory (ROM), electrically erasable programmable read-only memory (EEPROM), or other kinds of memory. Logic unit 110 may use memory, including some of storage 111, to hold intermediate computational results, executable microprocessor instructions, configuration information, or the like. At least a portion of storage 111 is used for relatively long term storage of digital photographs. Logic unit 110 may store digital image data in and retrieve digital image data from storage 111.

Storage 111 may include a removable device such as a semiconductor memory card in a format such as Compact Flash, Secure Digital, Smart Media, or Memory Stick, each available from several different suppliers. Storage 111 may also comprise a floppy disk or some other kind of nonvolatile re-writable medium. Typically, digital photographs are stored in storage 111 until they can be transferred or uploaded to a computer or other device. Photographs may be deleted from storage 111 so that storage 111 may be reused.

The camera may also comprise a display 109, which may be used for various purposes. Display 109 may provide a live viewfinder function, whereby the camera may repetitively display its rendition of the scene to aid the photographer in composing a photograph. Display 109 may also be used to review photographs for quality and composition. Display 109 may also be used in conjunction with user controls 112 to aid the photographer in controlling the function of the camera. For example, a selection of choices may be shown on display 109, and the user may select from the choices using user controls 112. User controls 112 may comprise buttons, dials, switches, touchpads, or other input devices.

FIG. 2 depicts a portion of an example camera user interface that will serve to demonstrate the basic operation of a typical digital camera. The user interface comprises both a display 109 and various user controls 201, 202, 203, 204. Mode dial 201 allows the photographer to change the operating mode of the camera. For example, the camera may be placed in a mode for taking photographs, a mode for review and management of photographs already taken, a mode for communicating with other devices, or other modes. In FIG. 2, the camera has been placed in a mode for review and management of existing photographs. The camera uses display 109 to display one of the existing photographs. Directional switch 202 may be used to traverse a series of photographs stored in storage 111, displaying each in turn. The photograph may fill only a portion of the display area. Other parts of the display screen may be used for other purposes, for example to communicate information about the photograph or to indicate a selection of operations that are available.

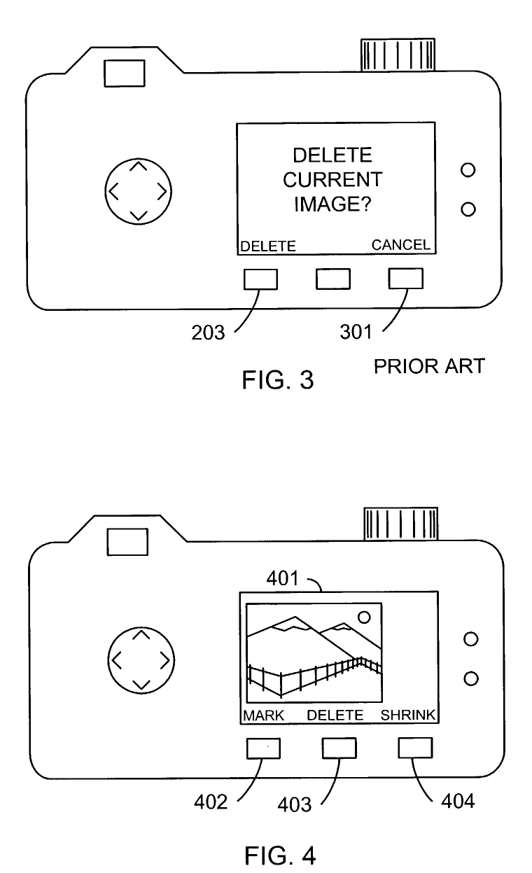

In FIG. 2, the camera indicates two choices, “Mark” and “Delete.” Each choice corresponds to and is selected by a button on the camera. In this example, the “Mark” function is selected by pressing button 203. The “Mark” function may be used to mark particular photographs for later batch operations or the like. In the example, the “Delete” function is selected by pressing button 204. Upon sensing the pressing of button 204, the camera presents a second user interface level requesting confirmation of the command to delete the photograph. This second level is depicted in FIG. 3. In this second level, button 301 cancels the delete operation, thus preserving the photograph in storage 111. Button 203 selects a “Delete” operation, confirming the photographer's wish to delete the photograph. When the camera senses the pressing of button 203 from this level, logic unit 110 proceeds to remove the photograph from storage 111, thus freeing the memory that the photograph consumed.

FIG. 4 depicts a camera that includes an example embodiment of the invention. The camera has been placed in a mode for review and management of existing photographs. A photograph is displayed using part of the area of display 401. Each of buttons 402, 403, and 404 corresponds to and selects a choice that is indicated in another part of the viewing area of display 401. An additional choice is now present, labeled “Shrink,” and corresponding to button 404. Appearing in the same set of selections provides an example of a way in which the “Shrink” choice and the “Delete” choice are associated with each other. When the camera detects the pressing of button 404, the photograph is read from storage 111, converted to a lower quality setting, and stored again in storage 111. The new version of the photograph generally consumes less memory than the original. The process of reading a photograph from storage 111, converting it to a lower quality setting, and storing it again in storage 111 may proceed sequentially or piecewise. That is, the photograph may be read completely and converted before any portion of it is stored again in storage 111, or sections of the photograph may be read, converted, and stored before other sections are read.

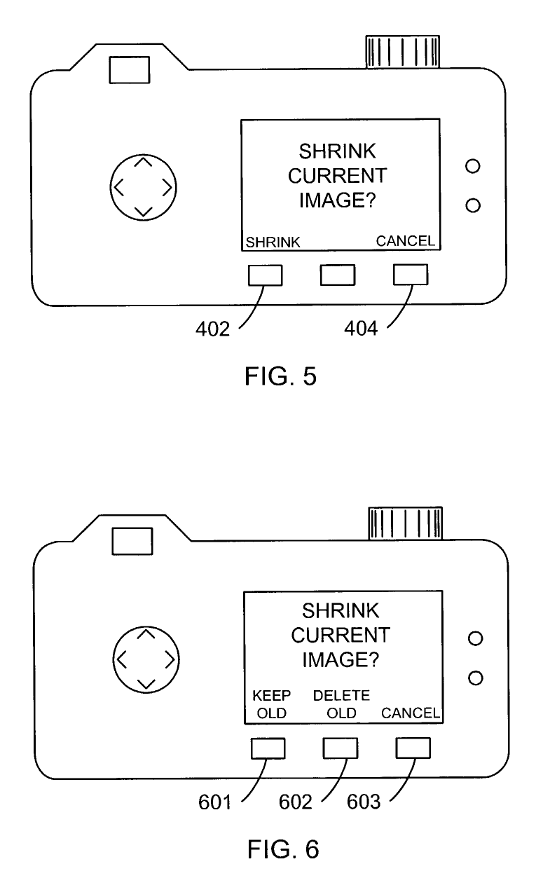

A confirmation step as shown in FIG. 5 may be provided. After button 404 is pressed, the camera may present the photographer with an opportunity to cancel the re-compression operation, in a manner similar to the confirmation required when a photograph is deleted. The example display shown in FIG. 5 notifies the photographer that a photograph is about to be re-compressed. Pressing button 402 confirms the size reduction, and pressing button 404 cancels the operation, leaving the photograph unchanged.

Of course, many variations are possible within the scope of the invention. For example, the operation choice may be labeled with some word other than “Shrink” to indicate that the photograph will be converted to a format that consumes less memory. For example, the choice could be labeled “Re-compress,” “Compress More,” “Crunch,” “Compact,” “Downsize,” “Reduce,” or some other descriptive word or phrase. The function may be indicated with an icon rather than a word or phrase.

If a particular photograph is already stored at the camera's lowest quality level, the camera may simply not present the operation choice for reducing the quality setting of the photograph, or the camera may present the operation choice “grayed-out” and inactive. Computers and other devices often present a menu choice in grayed-out inactive form when the choice is not applicable in a situation. The menu choice text is often displayed in gray or another subdued color to indicate the inactive state.

The camera may delete the original higher-quality photograph when a lower-quality photograph is created, or the original higher-quality photograph may be kept in storage 111. In another example embodiment, the photographer may be presented with a choice during the quality reduction operation, allowing the photographer to dictate the disposition of the original higher-quality photograph. FIG. 6 depicts a confirmation screen similar to that shown in FIG. 5, but with an additional choice presented. In this example embodiment, pressing button 601 confirms the quality reduction operation and indicates that the original higher-quality photograph is to be kept. Pressing button 602 confirms the quality reduction operation and indicates that the original higher-quality photograph is to be deleted. Pressing button 603 cancels the operation, leaving the camera's memory contents unchanged.

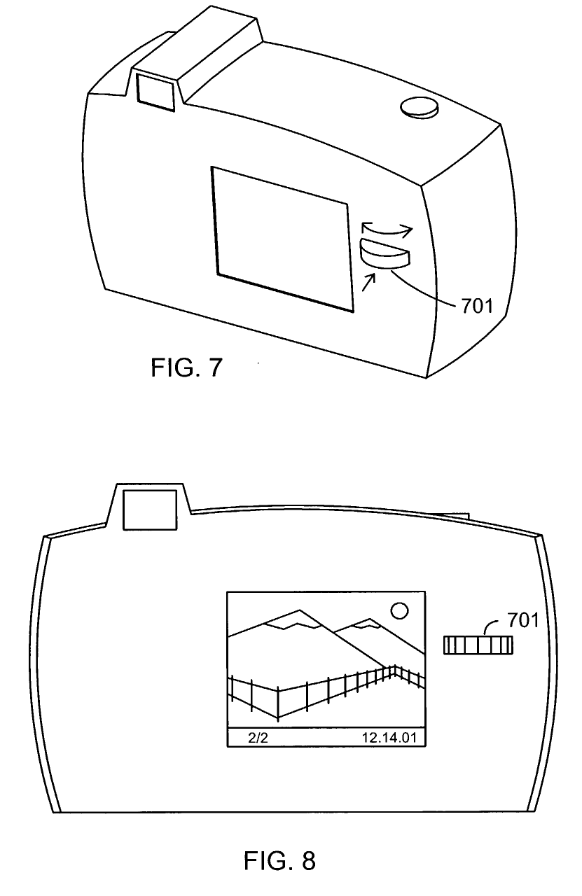

FIG. 7 depicts a rear perspective view of a second camera with a different user interface that includes a second example embodiment of the invention. This second camera includes user control 701 that serves as both a dial and a button. A generally circular moving member of user control 701 may be rotated about its axis. The rotation produces electrical signals that are detected by logic 110 and interpreted, for example, as progressively indicating operation choices in the camera. The generally circular moving member may also be displaced perpendicular to its axis, producing a different electrical signal. This signal may be detected by logic 110 and interpreted as initiating the operation indicated by a currently selected operation choice. Such a control device is an edge drive jog encoder, available from the Matsushita Electric Corporation of America in Secaucus, N.J.

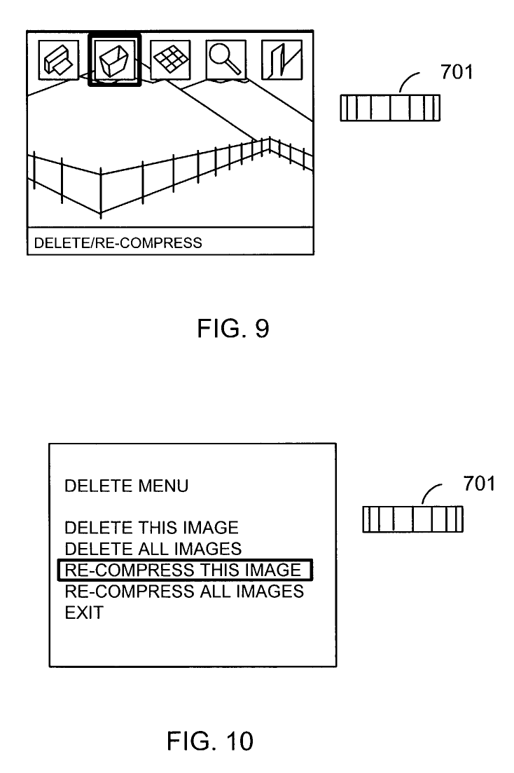

FIG. 8 shows a direct view of the display of the camera of FIG. 7, which may operate as follows. When the camera is in a mode for the review and management of photographs, such as may be shown in FIG. 8, rotating the substantially circular member of user control 701 may cause the photographs stored in the camera to be successively displayed. When a particular photograph is displayed, displacing control 701 may cause a menu of choices to be superimposed on the photograph in the display. This state is depicted in FIG. 9. The menu may present operations that may be performed on the particular photograph currently displayed, and may represent the choices with words or icons or both. Rotating control 701 may highlight or otherwise indicate successive menu choices. In FIG. 9, a menu choice represented by an icon showing a wastebasket is highlighted, indicating that operations relating to deleting a photograph may be selected.

Displacing control 701 may select the menu choice and present a menu such as is depicted in FIG. 10. Rotating control 701 may successively highlight or otherwise indicate the menu choices, and displacing control 701 may cause the highlighted operation to be performed.

The example menu in FIG. 10 presents operation choices relating to the deletion of photograph and re-compression of photographs, demonstrating another way in which deletion and re-compression choices may be associated with each other. If a particular photograph is already stored at the lowest quality setting available, then the menu choice indicating re-compression of the current photograph may be presented in grayed-out form and may be inactive. If all of the photographs stored in the camera are stored at the lowest quality setting available, then the menu choice indicating re-compression of all of the stored photographs may be presented in grayed-out form and may be inactive. Once the re-compression of a photograph is initiated, a confirmation screen analogous to FIG. 6 may be presented. The confirmation screen may allow the photographer to choose between deleting the original higher-quality photograph and deleting it, or such a choice may be presented at another stage in the operation.

A camera embodying the invention has several advantages. Associating the operation choices for deleting photographs and for re-compressing photographs allows the photographer to conveniently locate and operate the camera functions that involve memory recovery. When the re-compression function is selected to automatically delete the original larger photograph, the memory recovery is accomplished in one step (excluding confirmations). This arrangement saves the photographer the complex process of locating a re-compression function, executing the re-compression, locating a delete function in a separate menu, and executing the deletion.

The foregoing description of the present invention has been presented for purposes of illustration and description. It is not intended to be exhaustive or to limit the invention to the precise form disclosed, and other modifications and variations may be possible in light of the above teachings. For example, other user interfaces may be envisioned that associate re-compression of photographs with deletion of photograph, and other sorts of control devices may be used to implement the user interface. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A digital camera comprising:
a) storage that holds digital photographs;
b) logic that processes digital photographs; and
c) a user interface by which a user directs the logic to carry out operations, the user interface associating operation choices for deleting a digital photograph from the storage and for re-compressing a digital photograph.

2. The digital camera of claim 1 wherein an original photograph from which a re-compressed photograph is made is deleted from storage when the operation choice for re-compression is selected.

3. The digital camera of claim 1 wherein an original photograph from which a re-compressed photograph is made is kept in storage when the operation choice for re-compression is selected.

4. The digital camera of claim 1 further comprising an operation choice in the user interface comprising two settings such that:
a) when the user selects the first setting, an original photograph from which a re-compressed photograph is made is deleted from storage; and
b) when the user selects the second setting, an original photograph from which a re-compressed photograph is made is kept in storage.

5. The digital camera of claim 1 further comprising multiple quality levels at which photographs may be stored, and wherein the operation choice for re-compressing a photograph is indicated to be inactive when a photograph is already stored at the lowest quality setting.

6. A digital camera user interface wherein a choice by which a user directs the camera to delete a photograph is associated with a choice by which a user directs the camera to re-compress a photograph.

7. The digital camera user interface of claim 6 wherein the choice by which a user directs the camera to re-compress a photograph is indicated to be inactive when a photograph is stored at a lowest available quality level.

8. The digital camera user interface of claim 6 further comprising a second level with two choices such that:
a) when a user selects the first choice, an original photograph from which a re-compressed photograph is made is deleted; and
b) when a user selects the second choice, an original photograph from which a re-compressed photograph is made is kept.

9. The digital camera user interface of claim 6 comprising a choice by which a user directs the camera to re-compress all photographs contained in the camera.

10. A digital camera comprising:
a) logic means for deleting and re-compressing photographs;
b) user interface means by which the camera receives direction from a user, the user interface means associating operation choices by which the user directs the logic to delete a photograph and by which the user directs the logic to re-compress a photograph.

11. The camera of claim 10 wherein a photograph from which a re-compressed photograph is made is deleted.

12. The camera of claim 10 wherein a photograph from which a re-compressed photograph is made is not deleted.

13. The camera of claim 10 wherein the user interface means allows the user to specify whether to delete a photograph from which a re-compressed photograph is made.

14. The camera of claim 10 wherein the user interface means allows the user to direct the camera to re-compress all photographs contained in the camera.

15. A method of interacting with a user of a digital camera comprising the steps of:
a) presenting a selection of operation choices including choices for deleting and re-compressing an original image;
b) detecting the actuation of a user control directing the camera to re-compress the original image; and
c) re-compressing the original image, creating a re-compressed image from the original image.

16. The method of claim 15 further comprising the step of deleting the original image.

17. The method of claim 15 further comprising the step of presenting a second selection of operation choices including a choice indicating that the original image is to be deleted after re-compression, and a choice indicating that the original image is to be preserved.

18. The method of claim 15 wherein the operating choice for re-compressing an image is presented as inactive when the image is already stored at a lowest available quality setting.

19. The method of claim 15 further comprising the step of presenting an operation choice that allows the user to direct the camera to re-compress all of the images contained in the camera.
